(19) United States
(12) Patent Application Publication
(10) Pub. No.: US 2005/0170211 A1
(43) Pub. Date: Aug. 4, 2005

(54) Organic electroluminescent element

(75) Inventor: Kazushi Fujioka, Tenri-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/047,216

(22) Filed: Jan. 28, 2005

(30) Foreign Application Priority Data
Feb. 2, 2004 (JP) 2004-025729

(51) Int. Cl. H05B 33/12

(52) U.S. Cl. 428/690; 428/917; 313/504; 313/506

(57) ABSTRACT

An organic electroluminescent element comprising a hole injection electrode, an electron injection electrode and one kind or more of organic layers including a luminous layer between these electrodes, in which the organic layer includes a layer containing S, and metal or an oxide thereof is doped into the layer.

### CROSS-REFERENCE TO RELATED APPLICATION

This application is related to Japanese application No. 2004-25729 filed on Feb. 2, 2004, whose priority is claimed under 35 USC §119, the disclosure of which is incorporated by reference in its entirety.

### BACKGROUND OF THE INVENTION

1. Field of the Invention

The present invention relates to an organic electroluminescent element (hereinafter referred to as ‘an organic EL element’). More specifically, it relates to a long-life organic EL element capable of maintaining stable luminescent properties over a long period. The organic EL element of the present invention is appropriately employed for various kinds of displays mainly for information industry apparatuses.

2. Description of the Related Art

Electroluminescence (EL) has been known for long as a phenomenon such that zinc sulfide (ZnS)-based phosphor emits light in the case of impressing alternating high voltage thereon. With regard to an organic EL element, this luminous phenomenon is realized by using a fluorescent organic compound as a luminescent material.

Studies on the organic EL element have been conducted for long, and the basic structure thereof is a two-layer single hetero structure reported by Tang et al. in 1987. The structure is such that a hole transporting layer, an electron transporting layer functioning as a luminous layer and a metal cathode are sequentially laminated on a transparent electrode (ITO).

It was reported that such a structure ameliorated carrier recombination efficiency and allowed properties of a luminance of 1000 cd/m² or more, an outer quantum efficiency of 1.3% and a luminous efficiency of 1.51 m/W at a low voltage of 10 V or less. The organic EL element having this structure created the current way to put the organic EL element to practical use.

Thereafter, with regard to studies of the organic EL element, the following have been proposed: the amelioration of electron injection balance by the introduction of an electron transporting layer and the doping of the luminous layer with an electron transporting material, and the improvement of device structure by the confinement effect of exciton. Specifically, a structure has been proposed such as to separate the functions of hole transportation, electron transportation and luminescence to use an appropriate material for each of the necessary functions.

The above-mentioned structure dramatically improves the performance of the organic EL element, and an element having this structure has already been put to practical use in some quarters.

First studies of a polymeric organic EL element using a polymeric organic compound are a monolayer element using a poly (paraphenylene vinylene) (PPV) thin film made of a conductive polymer, which was presented by Burroughes et al. at Cambridge University in 1990.

Thereafter, in order to improve properties of luminescent wavelength, luminous efficiency, heat resistance and luminescent lifetime, the organic EL element has been actively studied and developed up to the present time, which uses a polymeric material such as a conjugated conductive polymer, for example, polyalkylthiophene and a pigment-containing polymer.

On the other hand, even though the organic EL element has high luminance and luminous efficiency and a low driving voltage at the initial drive, the problem is that continuous drive causes deterioration with time such as the decrease of luminance, the occurrence and growth of dark spots, the rise of driving voltage and the electrical short circuit.

Such deterioration is brought by some causes, which are roughly divided into interfacial phenomenon of lamination, thermal change and electrochemical instability. It is conceived that some specific factors result from used materials and polymeric materials have many causes of deterioration in common with low-molecular materials.

It is known in the polymeric organic EL element that the use of a polythiophene-based material PSS/PEDOT (polystyrene sulfonate/polyethylene dioxythiophene) containing S in the hole transporting layer allows luminescent properties and element lifetime to be improved among the above-mentioned problems.

A sulfur compound or a simple substance S (sulfur), however, easily moves (diffuses) through the atmosphere, liquid and solid, and thereby results in malfunction in various devices and measures against each of the malfunction have been studied.

M. P. de Jong reports the following about an element using PSS/PEDOT (PhD thesis, Eindhoven, 2000).

That is to say, with regard to the element using PSS/PEDOT, the desulfurization of a slight quantity of H₂O remaining in PSS/PEDOT and PSS causes a nonmetallic sulfur compound (such as sulfuric acid), which diffuses into the luminous layer. The diffused sulfur compound causes an oxidation-reduction reaction with a cathode on a luminous layer/cathode interface to form a new metallic sulfur compound layer. The impression of voltage promotes an oxidation-reduction reaction for forming the new metallic sulfur compound layer.

It is reported that this new metallic sulfur compound layer formed on a luminous layer/electron injection electrode interface results in element deterioration.

The use of an organic material not containing S is one means as measures against the above-mentioned element deterioration resulting from S. However, S is a component element of a necessary organic molecule for an organic EL element by reason of resulting in deterioration as described above and conversely having a function for improving luminescent properties and lifetime. In particular, the present state is such that a proper material having superior luminescent properties and lifetime to PSS/PEDOT is not found for the hole transporting layer in the polymeric organic EL element.

Under these circumstances, it has been desired that a means is developed, which restrains a nonmetallic sulfur compound or a simple substance S from moving onto an organic layer/cathode interface while retaining superior function of S.

### SUMMARY OF THE INVENTION

Through earnest studies for solving the above-mentioned problems, the inventor of the present invention has reached the present invention by finding out that the restraint of the movement of a nonmetallic sulfur compound or a simple substance S produced in a layer containing S in an organic layer including a luminous layer allows a long-life organic EL element in which the decrease of luminance and the rise of voltage due to the drive are extremely small, and stable luminescent properties are maintained over a long period.

Thus, the present invention provides an organic electroluminescent element comprising a hole injection electrode, an electron injection electrode and one kind or more of organic layers including a luminous layer between these electrodes, in which the organic layer includes a layer containing S, and metal or an oxide thereof is doped into the layer.

Also, the present invention provides an organic electroluminescent element comprising a hole injection electrode, an electron injection electrode and one kind or more of organic layers including a luminous layer between these electrodes, in which the organic layer includes a layer containing S and a layer doped with metal or an oxide thereof, and the layer doped with metal or the oxide thereof is located between the electron injection electrode and the layer containing S.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic cross-sectional view of the organic EL element of Embodiment 1 of the present invention.

FIG. 2 is a schematic cross-sectional view of the organic EL element of Embodiment 2 of the present invention.

### DETAILED DESCRIPTION OF PREFERRED EMBODIMENTS

The inventor of the present invention has found out through studies that;
(1) in an organic EL element using many organic materials having S as a component element except for PSS/PEDOT, a nonmetallic sulfur compound or a simple substance S is formed in a layer containing S to move into another layer,
(2) the nonmetallic sulfur compound or the simple substance S, which moved onto an electron injection electrode/organic layer interface, causes a chemical reaction such as an oxidation-reduction reaction with the electron injection electrode to form a new metallic sulfur compound, which results in element deterioration, and
(3) an impression of voltage promotes the oxidation-reduction reaction to progress deterioration at a prodigiously high rate as compared with the time when voltage is not impressed.

The above-mentioned content is further described hereinafter.

That is, a part of organic molecules contained in the organic layer cause a chemical reaction (desulfurization or reactions of desulfurized compounds) with dissolved impurities (such as oxygen, moisture and an organic solvent) in the layer, and is dissociated by the impression of voltage on an element and the stress such as heat during the manufacture of the element to produce new nonmetallic sulfur compound or simple substance S. The produced sulfur compound or simple substance S moves into another layer through diffusion.

The moved nonmetallic sulfur compound or simple substance S causes the oxidation-reduction reaction with the electron injection electrode on the electron injection electrode/organic layer interface to form a new metallic sulfur compound layer. This metallic sulfur compound layer results in element deterioration by reason of becoming a barrier to electron injection from the electron injection electrode into the organic layer, causing an abrupt shift of potential on the interface and trapping electrons.

The impression of voltage on the element continues to supply electrons from the electron injection electrode, so as to promote the production of the nonmetallic sulfur compound or the simple substance S by the oxidation-reduction reaction of organic molecules. An electric field caused by the impression of voltage increases the travel rate of the nonmetallic sulfur compound or the simple substance S through electro-migration. Thus, element deterioration is progressed at a prodigiously high rate as compared with the time when voltage is not impressed.

The inventor of the present invention has found out through further studies based on the above-mentioned knowledge that;
(1) in the organic EL element having the layer containing S, when metal or an oxide thereof is doped into the layer containing S or any one kind of organic layers between the electron injection electrode and the layer containing S, the diffusion of the nonmetallic sulfur compound or the simple substance S into another layer is restrained as compared with the time when not doped, and
(2) consequently, the movement of the nonmetallic sulfur compound or the simple substance S, which is caused at the time when voltage is impressed on the element, onto the organic layer/electron injection electrode interface through electro-migration is restrained.

A detailed mechanism of (1) and (2) has not been clarified yet, and is inferred as follows:
when metal or the oxide thereof exists in the layer containing S or any one kind of organic layers between the electron injection electrode and the layer containing S, the metal causes a chemical reaction with the nonmetallic sulfur compound or the simple substance S to form a new sulfur compound. The diffusion coefficient or the gradient of chemical potential of this sulfur compound is small as compared with those of the nonmetallic sulfur compound or the simple substance S, so that it is presumed that diffusion rate is decreased.
the nonmetallic sulfur compound or the simple substance S having positive charge causes a chemical reaction with metal or the oxide thereof to produce the new sulfur compound having no electric charge or less electric charge as compared with the nonmetallic sulfur compound or the simple substance S.
consequently, it is presumed that the quantity of the movement thereof onto the organic layer/electron injection electrode interface through electro-migration is decreased.

The present invention is specifically described hereinafter by using the following embodiments while referring Figures. These embodiments are examples, and various embodiments are practicable in the scope of the present invention.

### Embodiment 1

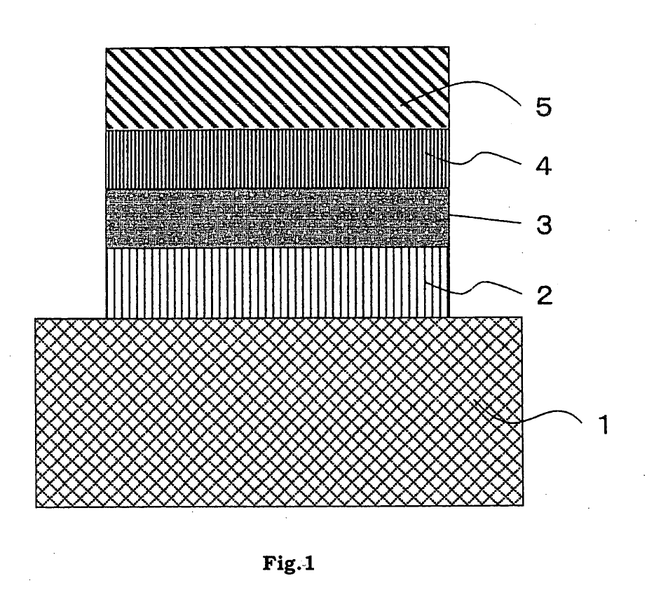

FIG. 1 is a schematic cross-sectional view of the principal part of layer constitution showing Embodiment 1 of the organic EL element of the present invention. This Embodiment 1 is characterized by comprising a hole injection electrode, an electron injection electrode and one kind or more of organic layers including a luminous layer between these electrodes, in which the organic layer includes a layer containing S, and metal or an oxide thereof is doped into the layer.

This organic EL element is constituted of a substrate 1, a hole injection electrode 2, an S-containing hole transporting layer 3, an electron transporting luminous layer 4 and an electron injection electrode 5, and metal or an oxide thereof is doped into the S-containing hole transporting layer.

The present invention is not limited to the above-mentioned constitution and may have the following layer constitutions. In the following, ‘a doping S-containing . . . layer’ signifies a layer containing metal or an oxide thereof and S.
(1) substrate/hole injection electrode/doping S-containing hole transporting layer/luminous layer/electron transporting layer/electron injection electrode
(2) substrate/electron injection electrode/electron transporting luminous layer/doping S-containing hole transporting layer/hole injection electrode
(3) substrate/electron injection electrode/electron transporting layer/luminous layer/doping S-containing hole transporting layer/hole injection electrode
(4) substrate/hole injection electrode/hole transporting layer/doping S-containing electron transporting luminous layer/electron injection electrode
(5) substrate/hole injection electrode/hole transporting layer/doping S-containing luminous layer/electron transporting layer/electron injection electrode
(6) substrate/electron injection electrode/doping S-containing electron transporting luminous layer/hole transporting layer/hole injection electrode
(7) substrate/electron injection electrode/electron transporting layer/doping S-containing luminous layer/hole transporting layer/hole injection electrode
(8) substrate/hole injection electrode/hole transporting layer/luminous layer/doping S-containing electron transporting layer/electron injection electrode
(9) substrate/electron injection electrode/doping S-containing electron transporting layer/luminous layer/hole transporting layer/hole injection electrode

The above-mentioned layer constitutions are examples, and layer constitutions may be any one in which metal or the oxide thereof is doped into the layer containing S and are not limited to the above.

Specific examples of metal or a metallic oxide to be doped include a simple substance or the oxide of metal selected from the group consisting of Zn, Al, Sb, Ir, In, U, Os, Cd, K, Ga, Ca, Ag, Cr, Si, Ge, Co, Hg, Sn, Sr, Cs, Tl, W, Ta, Ti, Fe, Cu, Cd, Th, Pb, Ni, Pt, Ba, Pd, V, Bi, As, Te, Mg, Mn, Mo, Li, Ru, Rb, Re and Rh.

These metals or oxides thereof react with the nonmetallic sulfur compound or the simple substance S produced in the layer containing S in the organic layer, and thereby have an effect of decreasing the quantity of the movement thereof onto the organic layer/electron injection electrode interface through electro-migration.

The dopant concentration of metal or the oxide thereof to be doped into the organic layer is not particularly limited, preferably 0.001 to 10 weight % and more preferably 0.01 to 1.0 weight %. It is not preferable that the dopant concentration of less than 0.001 weight % produces unreacted nonmetallic sulfur compound or simple substance S in large quantities, and it is not preferable that the dopant concentration of more than 10 weight % has a bad influence on the element, such as of causing leakage current.

A process of forming the organic layer to be doped with metal or the oxide thereof may be any process, which includes an evaporating process and a sputtering process. In the case of a formable raw material by the application of a solution, a process of applying a solution such as a spin-coating process and a dip-coating process can be used. In this case, an organic compound for forming the organic layer and a dopant may be used while dispersed into an inactive polymer with both.

An organic compound for forming the layer containing S to be used in the present invention may be either of a polymeric compound and a low-molecular compound, which include a compound capable of being used as any material, for example, a hole transporting material, a luminescent material and a doping material.

Specifically, examples of the polymeric compound include polystyrene sulfonate: PSS, polyethylene dioxythiophene: PEDOT, polythiophene acetate, poly(3-alkylthiophene): PAT, poly(3-hexylthiophene): PHT, poly(3-cyclohexylthiophene): PCHT, poly(3-cyclohexyl-4-methylthiophene): PCHMT, poly(3-[4-octylphenyl]-2,2′-bithiophene): PTOPT, poly(3-(4-octylphenyl)-thiophene): POPT and poly(3,4-dicyclohexylthiophene): PDCHT, and examples of the low-molecular compound include bis{4-[bis(4-methylphenyl)amino]phenyl}oligothiophene: BMA-nT, 5,5′-bis(dimesitylboryl)-2,2′-bithiophene: BMB-2T, benzothiazole zinc complex: Zn(BTZ)₂, oxadiazole zinc complex: Zn(ODZ)₂, coumarin 6, coumarin 540,2,5-bis(5-tert-butyl-2-benzooxazolyl)-thiophene: BBOT, tris(4,4,4-trifluoro-1-(2-thienyl)-1,3-butanediono)-1,10-phenanthroline europium(III): Eu(TTFA)3Phen, tris(4,4,4-trifluoro-1-(2-thienyl)-1,3-butanediono)-1,10-phenanthroline dysprosium(III): Dy(TTFA)3Phen, azabenzoxanthene: ABTX, cis-bis[2-(2′-thienyl)pyridinato-N,C3]Pt(II): PT(thpy) 2, SiTSTSi and TTSTT.

A molecule containing S as a component element except for the above can also be applied to the present invention.

The substrate to be used in the present invention is not particularly limited if a lamination plane thereof is composed of an insulating substance. However, the substrate made of a material having a high light transmittance is typically used in the case of taking light through the substrate.

Specific examples thereof include inorganic materials such as glass and quartz; plastics such as polyethylene terephthalate (PET), polycarbazole and polyimide; insulating substrates made of ceramics such as alumina; substrates such as to coat metallic substrates such as aluminum and iron with insulators such as SiO₂ and organic insulating materials; and substrates such as to perform insulating treatment on a surface of the metallic substrate such as aluminum by an anodizing process.

A material composing the hole injection electrode to be used in the present invention preferably has a large work function.

Specific examples thereof include metals (such as gold, platinum and nickel), transparent electrode materials [such as oxide (ITO) comprising indium and tin, oxide (IDIXO) comprising indium and zinc, and tin oxide] and polyaniline. The material having a high light transmittance is typically used in the case of taking light through the hole injection electrode. Examples of such a material include ITO, IDIXO, tin oxide, gold and polyaniline.

A material composing the electron injection electrode to be used in the present invention preferably has a small work function.

Specific examples thereof include a simple substance or an alloy of metals such as K, Li, Na, Mg, La, Ce, Ca, Sr, Ba, Al, Ag, In, Sn, Zn and Zr. The alloy thereof is preferable by reason of improving stability as the electrode.

Examples of the alloy include Ag Mg (Ag: 0.1 to 50 atm %), Al Li (Li: 0.01 to 14 atm %), In Mg (Mg: 50 to 80 atm %) and Al Ca (Ca: 0.01 to 20 atm %).

Fluorides (LiF, NaF, KF, RbF and CsF) or oxides (Li₂O, Na₂O, K₂O, Rb₂O and Cs₂O) of alkali metals such as Li, Na, K, Rb and Cs may be used as the electron injection electrode. The following can also be used: peroxides, complex oxides, halides except fluorides, nitrides and salts of alkali metals.

A monolayer thin film made of the above-mentioned materials or a multilayer thin film made of two kinds or more of materials is used for the electron injection electrode.

The organic layer to be used in the present invention may be a monolayer structure or a multilayer structure, and has at least a luminous layer and the layer containing S. Examples thereof include the following constitutions and the present invention is not limited thereto.
(1) luminous layer
(2) hole transporting layer/luminous layer
(3) luminous layer/electron transporting layer
(4) hole transporting layer/luminous layer/electron transporting layer
(5) hole injecting layer/hole transporting layer/luminous layer/electron transporting layer
(6) hole injecting layer/hole transporting layer/luminous layer/hole blocking layer/electron transporting layer

The luminous layer may contain a material except a luminescent material. For example, a luminous layer containing an electron transporting material may be referred to as an electron transporting luminous layer, and a luminous layer containing a hole transporting material as a hole transporting luminous layer.

Each of the luminous layer, the hole injecting layer, the hole transporting layer, the hole blocking layer and the electron transporting layer may be a monolayer structure or a multilayer structure, and both planes or one plane of the organic layer may further be provided with a buffering layer.

These layers can be constituted of known materials in the art and can be formed by known methods.

The film thickness of each layer in the organic layer is typically approximately 1 to 1000 nm.

Examples of a hole transporting material composing the hole transporting layer include low-molecular compounds such as benzidine derivative, styrylamine derivative, triphenylmethane derivative, triphenyl(or aryl)amine derivative and hydrazone derivative, and polymeric compounds such as polyaniline, polythiophene, polyvinyl carbazole and a mixture of poly(3,4-ethylene dioxythiophene) and polystyrene sulfonic acid.

Examples of a substance having a luminescent function composing a luminous layer include quinacridone pigment, rubrene pigment, styryl pigment; low-molecular compounds such as quinoline derivative as metal complex pigment having as ligand 8-quinolinols and derivatives thereof, such as tris(8-quinolinolato)aluminum (Alq3), tetraphenylbutadiene derivative, anthracene derivative, perylene derivative, coronene derivative, 12-phthaloperinone derivative, phenylanthracene derivative and tetraarylethene derivative, and polymeric compounds such as polystyrene, polymethyl methacrylate and polyvinyl carbazole in which fluorescent pigments such as coumarin, perylene, pyran, anthrone, porphyrene, quinacridone, N,N′-dialkyl-substituted quinacridone, naphthalimide and N,N′-diaryl-substituted pyrrolopyrrole are dissolved; and polymeric fluophor such as polyarylvinylene and polyfluorene.

Examples of an electron transporting material composing the electron transporting layer include quinoline derivative of organometallic complex having as ligand 8-quinolinols and derivatives thereof, such as tris(8-quinolinolato)aluminum (Alq3), oxadiazole derivative, perylene derivative, pyridine derivative, pyrimidine derivative, quinoxaline derivative, diphenylquinone derivative and nitro-substituted fluorine derivative.

The organic EL element of the present invention may be provided with a known polarizing plate on the opposite plane of the substrate to an electrode-forming plane for improving the contrast of the organic EL element, and may be provided with known sealing film or sealing substrate such as glass on the opposite plane of the substrate for preventing outer oxygen and moisture from contaminating into the element and improving the lifetime of the organic EL element.

### Embodiment 2

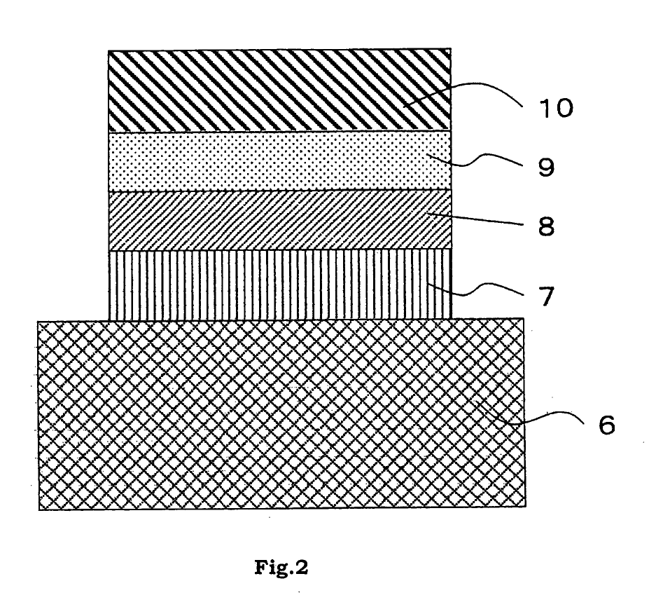

FIG. 2 is a schematic cross-sectional view of the principal part of layer constitution showing Embodiment 2 of the organic EL element of the present invention. This Embodiment 2 is characterized by comprising a hole injection electrode, an electron injection electrode and one kind or more of an organic layer including a luminous layer between these electrodes, in which the organic layer includes a layer containing S and a layer doped with metal or an oxide thereof, and the layer doped with metal or an oxide thereof is located between the electron injection electrode and the layer containing S.

This organic EL element is constituted of a substrate 6, a hole injection electrode 7, an S-containing hole transporting layer 8, an electron transporting luminous layer 9 and an electron injection electrode 10, and one kind of metal or an oxide thereof is doped into the electron transporting luminous layer between the S-containing hole transporting layer and the electron injection electrode.

The present invention is not limited to the above-mentioned constitution and may have the following layer constitutions. In the following, ‘a doping . . . layer’ signifies a layer containing metal or an oxide thereof.
(1) substrate/hole injection electrode/S-containing hole transporting layer/doping luminous layer/electron transporting layer/electron injection electrode
(2) substrate/hole injection electrode/S-containing hole transporting layer/luminous layer/doping electron transporting layer/electron injection electrode
(3) substrate/electron injection electrode/doping electron transporting luminous layer/S-containing hole transporting layer/hole injection electrode
(4) substrate/electron injection electrode/electron transporting layer/doping luminous layer/S-containing hole transporting layer/hole injection electrode
(5) substrate/electron injection electrode/doping electron transporting layer/luminous layer/S-containing hole transporting layer/hole injection electrode
(6) substrate/hole injection electrode/hole transporting layer/S-containing luminous layer/doping electron transporting layer/electron injection electrode
(7) substrate/electron injection electrode/doping electron transporting layer/S-containing luminous layer/hole transporting layer/hole injection electrode

The above-mentioned layer constitutions are examples, and layer constitutions may be any one, in which metal or the oxide thereof is doped into the organic layer between the layer containing S and the electron injection electrode, and are not limited to the above.

With regard to Embodiment 2, metal or the oxide thereof to be doped, the organic compound containing S, the substrate, the hole injection electrode, the electron injection electrode and the organic layer are subject to the same as Embodiment 1.

Even in the case of being an alloy, such as AgMg, AlLi, InMg and AlCa, made of two kinds or more selected from the group consisting of Zn, Al, Sb, Ir, In, U, Os, Cd, K, Ga, Ca, Ag, Cr, Si, Ge, Co, Hg, Sn, Sr, Cs, Tl, W, Ta, Ti, Fe, Cu, Cd, Th, Pb, Ni, Pt, Ba, Pd, V, Bi, As, Te, Mg, Mn, Mo, Li, Ru, Rb, Re and Rh, or an oxide of the above-mentioned alloy, such as AgMgO, AlLiO, InMgO and AlCaO, metal or the oxide thereof to be doped, which is used in the present invention, reacts with a nonmetallic sulfur compound or a simple substance S produced in the layer containing S in the organic layer, and thereby have an effect of decreasing the quantity of the movement thereof onto the organic layer/electron injection electrode interface through electro-migration.

The constitutions of Embodiments 1 and 2 may be combined.

### EXAMPLES

The present invention is described more specifically on the basis of examples and comparative examples. In the examples, metal Ag or alloy Ag—Mg is used and the effect is described. Materials and the quantity thereof and the conditions of numerical values such as treatment temperature and treatment time, which were used in the examples, are merely one example, and the present invention is not limited to these examples.

### Example 1

A two-layer element was manufactured as the organic EL element of the present invention in the following manner.

First, an ITO film as a hole injection electrode was formed on a glass substrate by a sputtering process so that a film thickness became 100 nm. The sheet resistance of the obtained ITO film was 10 Ω/□ or less.

Next, the ITO film was subject to photolithography and etching treatments to form a 2 mm-wide beltlike hole injection electrode. A glass substrate on which this hole injection electrode was formed was subject to ultrasonic cleaning for 10 minutes with each of acetone and IPA (2-propanol), and thereafter dried.

Next, a 65 nm-thick metal-doping S-containing hole transporting layer was formed with a spin coater by using coating liquid for forming a metal-doping S-containing hole transporting layer. Here, a solution, in which PEDOT/PSS (5 mg/95 mg) and nano particles (0.1 mg) of Ag were dispersed into pure water (10 ml), was used as the coating liquid for forming a metal-doping S-containing hole transporting layer.

Next, this substrate was dried by heating in an atmosphere of high-purity nitrogen at a temperature of 200° C. for 5 minutes to remove a solvent in the hole transporting layer.

Next, a 70 nm-thick luminous layer was formed on the above-mentioned metal-doping S-containing hole transporting layer with a spin coater by using coating liquid for forming an electron transporting luminous layer. Here, a solution, in which poly(2-methoxy-5-(2′-ethylhexyloxy)-1,4-phenylene vinylene) (hereinafter referred to as MEH-PPV) (100 mg) was dissolved in 10 ml of xylene, was used as the coating liquid for forming the electron transporting luminous layer.

Next, this substrate was dried by heating in an atmosphere of high-purity nitrogen at a temperature of 90° C. for 1 hour to remove a solvent in the layer.

Thereafter, the glass substrate, on which the hole injection electrode, the hole transporting layer and the luminous layer were formed, was placed in a vacuum evaporator for forming an electrode to form on the luminous layer an electron injection electrode such that the thickness of Ca became 2.5 nm and subsequently the thickness of Al became 100 nm by a vacuum evaporating process with the use of a stainless-steel metallic mask.

Thus, the 2 mm-wide beltlike electron injection electrode made of a Ca/Al layer, which was orthogonal to the hole injection electrode, was formed to obtain the organic EL element.

Lastly, a sealing glass was stuck to the glass substrate by used an ultraviolet-curing resin so as to cover the organic EL element.

### Example 2

The organic EL element was obtained in the same manner as Example 1 except for forming an alloy-doping S-containing hole transporting layer [Ag—Mg (0.01 mg-0.09 mg), PEDOT/PSS] instead of the metal-doping S-containing hole transporting layer (Ag, PEDOT/PSS).

### Example 3

A two-layer element was manufactured as the organic EL element of the present invention in the following manner.

First, ITO as a hole injection electrode was formed on a glass substrate by a sputtering process so that a film thickness became 100 nm. The sheet resistance of the obtained ITO film was 10 Ω/□ or less.

Next, the ITO film was subject to photolithography and etching treatments to form a 2 mm-wide beltlike hole injection electrode. A glass substrate on which this hole injection electrode was formed was subject to ultrasonic cleaning for 10 minutes with each of acetone and IPA (2-propanol), and thereafter dried.

Next, a 65 nm-thick hole transporting layer was formed with a spin coater by using coating liquid for forming an S-containing hole transporting layer. Here, a solution, in which PEDOT/PSS (5 mg/95 mg) was dispersed into pure water (10 ml), was used as the coating liquid for forming an S-containing hole transporting layer.

Next, this substrate was dried by heating in an atmosphere of high-purity nitrogen at a temperature of 200° C. for 5 minutes to remove a solvent in the hole transporting layer.

Next, a 70 nm-thick metal-doping electron transporting luminous layer was formed on the above-mentioned hole transporting layer with a spin coater by using coating liquid for forming a metal-doping electron transporting luminous layer. Here, a solution, in which MEH-PPV (100 mg) and nano particles (0.1 mg) of Ag were dispersed into 10 ml of pure water, was used as the coating liquid for forming the metal-doping electron transporting luminous layer.

Next, this substrate was dried by heating in an atmosphere of high-purity nitrogen at a temperature of 90° C. for 1 hour to remove a solvent in the layer.

Thereafter, the glass substrate, on which the hole injection electrode, the hole transporting layer and the luminous layer were formed, was placed in a vacuum evaporator for forming an electrode to form on the luminous layer an electron injection electrode such that the thickness of Ca became 2.5 nm and subsequently the thickness of Al became 100 nm by a vacuum evaporating process with the use of a stainless-steel metallic mask.

Thus, the 2 mm-wide beltlike electron injection electrode made of a Ca/Al layer, which was orthogonal to the hole injection electrode, was formed to obtain the organic EL element.

Lastly, a sealing glass was stuck to the glass substrate by used an ultraviolet-curing resin so as to cover the organic EL element.

### Example 4

The organic EL element was obtained in the same manner as Example 3 except for forming an alloy-doping electron transporting luminous layer [Ag—Mg (0.01 mg-0.09 mg), MEH-PPV] instead of the metal-doping electron transporting luminous layer (Ag, MEH-PPV).

### Comparative Example 1

An organic EL element was obtained in the same manner as Example 1 except for forming a hole transporting layer (PEDOT/PSS) instead of the metal-doping hole transporting layer (Al, PEDOT/PSS).

### Example 5

A two-layer element was manufactured as the organic EL element of the present invention in the following manner.

First, ITO as a hole injection electrode was formed on a glass substrate by a sputtering process so that a film thickness became 100 nm. The sheet resistance of the obtained ITO film was 10 Ω/□ or less.

Next, the ITO film was subject to photolithography and etching treatments to form a 2 mm-wide beltlike hole injection electrode. A glass substrate on which this hole injection electrode was formed was subject to ultrasonic cleaning for 10 minutes with each of acetone and IPA (2-propanol), and thereafter dried.

Next, a 65 nm-thick hole transporting layer was formed with a spin coater by using coating liquid for forming a hole transporting layer. Here, a solution, in which poly(N,N′-diphenyl-N,N′-bis-(3-methylphenyl)-[1,1′-biphenyl]-4,4′-diamine) (hereinafter referred to as Poly-TPD) (100 mg) was dispersed into dimethylformamide (10 ml), was used as the coating liquid for forming the hole transporting layer.

Next, this substrate was dried by heating in an atmosphere of high-purity nitrogen at a temperature of 200° C. for 5 minutes to remove a solvent in the hole transporting layer.

Next, a 70 nm-thick metal-doping S-containing electron transporting luminous layer was formed on the above-mentioned hole transporting layer with a spin coater by using coating liquid for forming a metal-doping S-containing electron transporting luminous layer. Here, a solution, in which poly(3-hexylthiophene) (hereinafter referred to as PHT) (100 mg) and Ag (0.1 mg) were dispersed into xylene (10 ml), was used as the coating liquid for forming the metal-doping S-containing electron transporting luminous layer.

Next, this substrate was dried by heating in an atmosphere of high-purity nitrogen at a temperature of 90° C. for 1 hour to remove a solvent in the layer.

Thereafter, the glass substrate, on which the hole injection electrode, the hole transporting layer and the luminous layer were formed, was placed in a vacuum evaporator for forming an electrode to form on the luminous layer an electron injection electrode such that the thickness of Ca became 2.5 nm and subsequently the thickness of Al became 100 nm by a vacuum evaporating process with the use of a stainless-steel metallic mask.

Thus, the 2 mm-wide beltlike electron injection electrode made of a Ca/Al layer, which was orthogonal to the hole injection electrode, was formed to obtain the organic EL element.

Lastly, a sealing glass was stuck to the glass substrate by used an ultraviolet-curing resin so as to cover the organic EL element.

### Example 6

An organic EL element was obtained in the same manner as Example 5 except for forming an alloy-doping electron transporting luminous layer [Ag—Mg (0.01 mg-0.09 mg), PHT] instead of the metal-doping S-containing electron transporting luminous layer (Ag, PHT).

### Comparative Example 2

An organic EL element was obtained in the same manner as Example 5 except for forming an electron transporting S-containing luminous layer (PHT) instead of the metal-doping S-containing electron transporting luminous layer (Ag, PHT).

Direct voltage was impressed on each of the organic EL elements manufactured in the manner described above, which elements were continuously driven at a constant current density of 10 mA/cm² to evaluate properties thereof.

Relative initial luminance and relative luminance half-lifetime of each element are shown in Table 1.

TABLE 1

| | Relative Initial | Relative Luminance |
|---|---|---|
| | Luminance | Half-lifetime |
| Comparative | 1 | 1 |
| Example 1 | | |
| Example 1 | 1.3 | 10.5 |
| Example 2 | 1.2 | 9.5 |
| Example 3 | 1.2 | 7.0 |
| Example 4 | 1.1 | 6.0 |
| Comparative | 1 | 1 |
| Example 2 | | |
| Example 5 | 1.1 | 5.0 |
| Example 6 | 1.1 | 4.5 |

It is understood from the results of Table 1 that the elements of Examples 1 to 4 allow the decrease of luminance due to element drive to be restrained and the lifetime to become longer as compared with that of Comparative Example 1, and much the same is true on the elements of Examples 5 and 6 as compared with that of Comparative Example 2.

According to the present invention, the nonmetallic sulfur compound or the simple substance S produced in the layer containing S hardly moves between the organic layer and the electron injection electrode, and the decrease of luminance and the rise of voltage due to the element drive are extremely small. Thus, the long-life organic EL element in which stable luminescent properties are maintained over a long period can be obtained.

1. An organic electroluminescent element comprising a hole injection electrode, an electron injection electrode and one kind or more of organic layers including a luminous layer between these electrodes, in which the organic layer includes a layer containing S, and metal or an oxide thereof is doped into the layer.

2. The organic electroluminescent element of claim 1, wherein the metal or the oxide thereof is an alloy or an oxide thereof.

3. The organic electroluminescent element of claim 1, wherein the metal or the oxide thereof is a simple substance, an alloy or an oxide of metal selected from the group consisting of Zn, Al, Sb, Ir, In, U, Os, Cd, K, Ga, Ca, Ag, Cr, Si, Ge, Co, Hg, Sn, Sr, Cs, Ti, W, Ta, Ti, Fe, Cu, Cd, Th, Pb, Ni, Pt, Ba, Pd, V, Bi, As, Te, Mg, Mn, Mo, Li, Ru, Rb, Re and Rh.

4. The organic electroluminescent element of claim 1, wherein the layer doped the metal or the oxide thereof contains the metal or the oxide thereof of a dopant concentration 0.001 to 10 weight %.

5. The organic electroluminescent element of claim 1, wherein the layer containing S is an organic layer contained a compound selected from the group consisting of polystyrene sulfonate: PSS, polyethylene dioxythiophene: PEDOT, polythiophene acetate, poly(3-alkylthiophene): PAT, poly(3-hexylthiophene): PHT, poly(3-cyclohexylthiophene): PCHT, poly(3-cyclohexyl-4-methylthiophene): PCHMT, poly(3-[4-octylphenyl]-2,2′-bithiophene): PTOPT, poly(3-(4-octylphenyl)-thiophene): POPT, poly(3,4-dicyclohexylthiophene): PDCHT, bis{4-[bis(4-methylphenyl)amino]phenyl}oligothiophene: BMA-nT, 5,5′-bis(dimesitylboryl)-2,2′-bithiophene: BMB-2T, benzothiazole zinc complex: Zn(BTZ)₂, oxadiazole zinc complex: Zn(ODZ)₂, coumarin 6, coumarin 540,2,5-bis(5-tert-butyl-2-benzooxazolyl)-thiophene: BBOT, tris(4,4,4-trifluoro-1-(2-thienyl)-1,3-butanediono)-1,10-phenanthroline europium(III): Eu(TTFA)3Phen, tris(4,4,4-trifluoro-1-(2-thienyl)-1,3-butanediono)-1,10-phenanthroline dysprosium(III): Dy(TTFA)3Phen, azabenzoxanthene: ABTX, cis-bis[2-(2′-thienyl)pyridinato-N,C3]Pt(II): PT(thpy) 2, SiTSTSi and TTSTT.

6. The organic electroluminescent element of claim 5, wherein the layer containing S is an organic layer contained PSS or PEDOT.

7. The organic electroluminescent element of claim 1, wherein the layer containing S is a hole transporting layer, an electron transporting luminous layer, the luminous layer or an electron transporting layer.

8. An organic electroluminescent element comprising a hole injection electrode, an electron injection electrode and one kind or more of organic layers including a luminous layer between these electrodes, in which the organic layer includes a layer containing S and a layer doped with metal or an oxide thereof, and the layer doped with metal or the oxide thereof is located between the electron injection electrode and the layer containing S.

9. The organic electroluminescent element of claim 8, wherein the metal or the oxide thereof is an alloy or an oxide thereof.

10. The organic electroluminescent element of claim 8, wherein the metal or the oxide thereof is a simple substance, an alloy or an oxide of metal selected from the group consisting of Zn, Al, Sb, Ir, In, U, Os, Cd, K, Ga, Ca, Ag, Cr, Si, Ge, Co, Hg, Sn, Sr, Cs, Tl, W, Ta, Ti, Fe, Cu, Cd, Th, Pb, Ni, Pt, Ba, Pd, V, Bi, As, Te, Mg, Mn, Mo, Li, Ru, Rb, Re and Rh.

11. The organic electroluminescent element of claim 8, wherein the layer doped the metal or the oxide thereof contains the metal or the oxide thereof of a dopant concentration 0.001 to 10 weight %.

12. The organic electroluminescent element of claim 8, wherein the layer containing S is an organic layer contained a compound selected from the group consisting of polystyrene sulfonate: PSS, polyethylene dioxythiophene: PEDOT, polythiophene acetate, poly(3-alkylthiophene): PAT, poly(3-hexylthiophene): PHT, poly(3-cyclohexylthiophene): PCHT, poly(3-cyclohexyl-4-methylthiophene): PCHMT, poly(3-[4-octylphenyl]-2,2′-bithiophene): PTOPT, poly(3-(4-octylphenyl)-thiophene): POPT, poly(3,4-dicyclohexylthiophene): PDCHT, bis{4-[bis(4-methylphenyl)amino]phenyl}oligothiophene: BMA-nT, 5,5′-bis(dimesitylboryl)-2,2′-bithiophene: BMB-2T, benzothiazole zinc complex: Zn(BTZ)₂, oxadiazole zinc complex: Zn(ODZ)₂, coumarin 6, coumarin 540,2,5-bis(5-tert-butyl-2-benzooxazolyl)-thiophene: BBOT, tris(4,4,4-trifluoro-1-(2-thienyl)-1,3-butanediono)-1,10-phenanthroline europium(III): Eu(TTFA)3Phen, tris(4,4,4-trifluoro-1-(2-thienyl)-1,3-butanediono)-1,10-phenanthroline dysprosium(III): Dy(TTFA)3Phen, azabenzoxanthene: ABTX, cis-bis[2-(2′-thienyl)pyridinato-N,C3]Pt(II): PT(thpy)2, SiTSTSi and TTSTT.

13. The organic electroluminescent element of claim 12, wherein the layer containing S is an organic layer contained PSS or PEDOT.

14. The organic electroluminescent element of claim 8, wherein the layer containing S is a hole transporting layer, an electron transporting luminous layer, the luminous layer or an electron transporting layer.
